(19) United States
(12) Patent Application Publication
(10) Pub. No.: US 2004/0216726 A1
(43) Pub. Date: Nov. 4, 2004

(54) Exhaust gas purifying device for engines

(76) Inventors: Yoshiaki Hori, Saitama (JP); Tohru Nishi, Saitama (JP)

Correspondence Address: BIRCH STEWART KOLASCH & BIRCH, PO BOX 747, FALLS CHURCH, VA, 22040-0747, US

(21) Appl. No.: 10/775,209

(22) Filed: Feb. 11, 2004

(30) Foreign Application Priority Data
Feb. 13, 2003 (JP) 2003-034738

(51) Int. Cl. F02D 41/00

(52) U.S. Cl. 123/699

(57) ABSTRACT

An engine is disposed with a crankshaft axially oriented in the longitudinal direction of the vehicle body. A camshaft and an exhaust port in a cylinder head are disposed parallel to the crankshaft. The exhaust port is open at the front surface of the cylinder head, and discharges exhaust gases through an exhaust pipe. Hoses extend from a radiator in front of the engine to the front surface of the engine. A valve case is disposed on a left side of a cylinder block in the vicinity of the exhaust port to which the exhaust pipe is connected, and is connected to an air cleaner behind the engine by a substantially straight secondary air pipe.

### CROSS-REFERENCE TO RELATED APPLICATIONS

The present application claims priority under 35 USC 119 to Japanese Patent Application No. 2003-034738 filed on Feb. 13, 2003 the entire contents thereof is hereby incorporated by reference.

### BACKGROUND OF THE INVENTION

1. Field of the Invention

The present invention relates to an exhaust gas purifying device for a four-cycle engine, and more particularly to an exhaust gas purifying device that can easily be disposed with respect to a valve operating mechanism, a coolant piping, etc.

2. Description of Background Art

Exhaust gas purifying devices are known for supplying secondary air to the exhaust port of four-cycle engines. The exhaust gas purifying devices have a reed valve disposed in the vicinity of the exhaust port. The exhaust port is disposed substantially perpendicularly to a camshaft as viewed in a plan view of the engine, and the reed valve has a valve case disposed on a side wall of a cylinder block below the exhaust port. The exhaust port is supplied with secondary air through a secondary air supply passage that is defined in the cylinder block and a cylinder head. See, Japanese Utility Model Publication No. Sho 61-4022.

On some rough terrain vehicles such as buggies, an engine is mounted with its crankshaft axially oriented in the longitudinal direction of the vehicle body and has exhaust ports directed parallel to a camshaft as viewed in a plan view of the engine and forward of the vehicle body. If the engine is a water-cooled engine, then a radiator is disposed forward of the engine, and a water pump, a thermostat, and water inlet and outlet pipes associated therewith are disposed in front of the engine.

In the engine of the type described above, since the camshaft actuating device and the water coolant pipes are positioned together in front of the engine, it is extremely difficult in the layout to position the reed valve on a front face of the cylinder block below the exhaust port as disclosed in Japanese Utility Model Publication No. Sho 61-4022. Therefore, there is a demand for an exhaust gas purifying device that can be installed even if the camshaft actuating device, or the water coolant pipes, or both are disposed in the vicinity of the opening of the exhaust port, in the above engine configuration.

However, if the reed valve is disposed in front of the engine, then the secondary air supply passage extending from the exhaust port to the reed valve is short, but the pipe extending from the reed valve to the air cleaner is considerably long because it needs to extend around the engine from the position in front of the engine through the position above the engine. It is desirable to make the pipe as short as possible from the standpoints of the ease with which the engine is installed on the vehicle body and the mechanical strength of the pipe. It is an object of the present invention to meet the above demands.

### SUMMARY AND OBJECTS OF THE INVENTION

To solve the above problems, there is provided an exhaust gas purifying device for a four-cycle engine having a secondary air supply passage for supplying secondary air to an exhaust port and a valve for opening and closing the secondary air supply passage with exhaust pulsations. The exhaust port is disposed parallel to a camshaft as viewed in a plan view of the engine, and the valve is disposed on a side of the engine which is perpendicular to the camshaft.

According to the present invention, the valve is disposed on either a left or right side of a vehicle body, and a pipe for supplying the secondary air is connected between the valve and an air cleaner disposed behind the engine.

According to the present invention, if a camshaft actuating device or water coolant piping required by the engine, which is water-cooled, is disposed on a side of the engine where the exhaust port is open, then there is almost no space available on the side of the engine for installing the valve of the exhaust gas purifying device thereon. However, with the valve of the exhaust gas purifying device being disposed on the side of the engine to be perpendicular to the camshaft, the valve is disposed on the surface that is different from the side of the engine where the exhaust port is open. As a result, since a camshaft actuating device and a water coolant piping are not present on that surface, the valve can be installed without interference therewith, and hence there is a large freedom with which to install the valve.

According to the present invention, since the valve is disposed on either a left or right side of the vehicle body, the secondary air pipe from the valve and the engine to the air cleaner behind the engine can extend substantially straight without having to extend around the engine from the position in front of the engine through the position above the engine. Therefore, the secondary air pipe can easily be laid out and have the desired mechanical strength. Since the secondary air pipe is shorter than the conventional secondary air pipe and does not extend above the engine, the overall height of the engine can be reduced, and both the installability of the engine on the vehicle and the maintainability of the valve on the vehicle are improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side elevational view of a vehicle to which a first embodiment of the present invention is applied;

FIG. 2 is a front elevational view of an engine;

FIG. 3 is a plan view of a cylinder head;

FIG. 4 is a bottom view of the cylinder head;

FIG. 5 is a plan view of a cylinder;

FIG. 6 is a cross-sectional view taken along line 6-6 of FIG. 5;

FIG. 7 is a front elevational view of an engine according to a second embodiment of the present invention;

FIG. 8 is a view showing a cam chain; and

FIG. 9 is a fragmentary cross-sectional view of the engine.

### DETAILED DESCRIPTION OF THE PREFERRED EMBODIMENTS

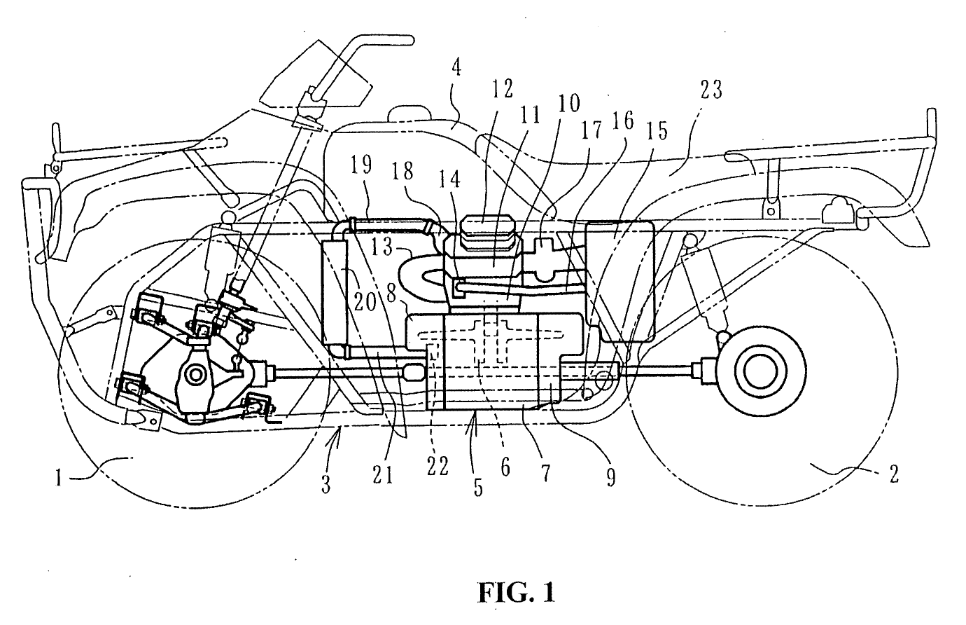

Embodiments of the present invention will be described below with reference to the drawings. FIGS. 1 through 6 show a first embodiment of the present invention. In the present application, the terms “forward,” “rearward,” “above,” “below,” “left,” and “right” refer to directions with respect to the direction in which the vehicle body travels.

As shown in FIG. 1, the buggy has a vehicle frame 3 for supporting front wheels 1 including left and right wheels and for supporting rear wheels 2 including left and right wheels. A fuel tank 4 is supported centrally above the vehicle frame 3 and an engine 5 is mounted on the vehicle frame 3 below the fuel tank 4.

The engine 5 is a water-cooled four-cycle engine having a crankshaft 6 axially extending in the longitudinal direction of the vehicle body. The engine 5 has a transmission chamber 8 disposed forward of and integral with a crankshaft chamber 7 and an ACG chamber 9 disposed rearwardly of and integral with the crankshaft chamber 7. The front wheels I and the rear wheels 2 are driven by the engine 5 through shafts. The engine 5 has a cylinder block 10, a cylinder head 11, and a cylinder head cover 12.

The engine 5 draws air from a rear surface of the cylinder head 11 and discharges exhaust gases from a front surface of the cylinder head 11 through an exhaust pipe 13. The exhaust pipe 13 extends forwardly and is then bent back and, though not shown, extends along a side of the cylinder head 11 rearwardly of the vehicle body.

A valve case 14 of an exhaust gas purifying device is disposed on the left side of the cylinder block 10 in the vicinity of a joint of the exhaust pipe 13. To the valve case 14, there is connected a secondary air pipe 16 extending rearwardly substantially straight as viewed in side elevation (as shown) and connected to an air cleaner 15.

Clean air is supplied as secondary air from the air cleaner 15 through the secondary air pipe 16 into the valve case 14. The air cleaner 15 is vertically long and is rearwardly of the engine 5 and has a large volume, and supplies air through a carburetor 17 to an intake port (described later on) of the cylinder head 11.

An upper water hose 19 has an end connected to an upper portion of the front surface of the cylinder head 11 through a thermostat housing 18. The other end of the upper water hose 19 is connected to an upper tank of a radiator 20 disposed in front of the engine 5. A lower water hose 21 extends from a lower tank of the radiator 20 and is connected to a water pump 22 disposed on a lower portion of a front surface of the transmission chamber 8. The water pump 22 delivers a coolant supplied from the lower water hose 21 into a water jacket of the engine 5. A seat 23 is disposed on the vehicle frame 3.

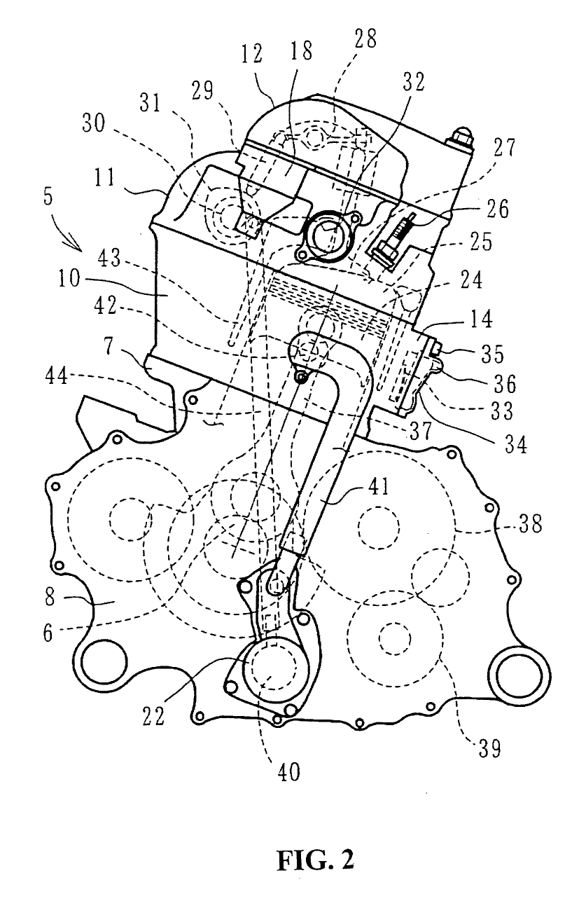

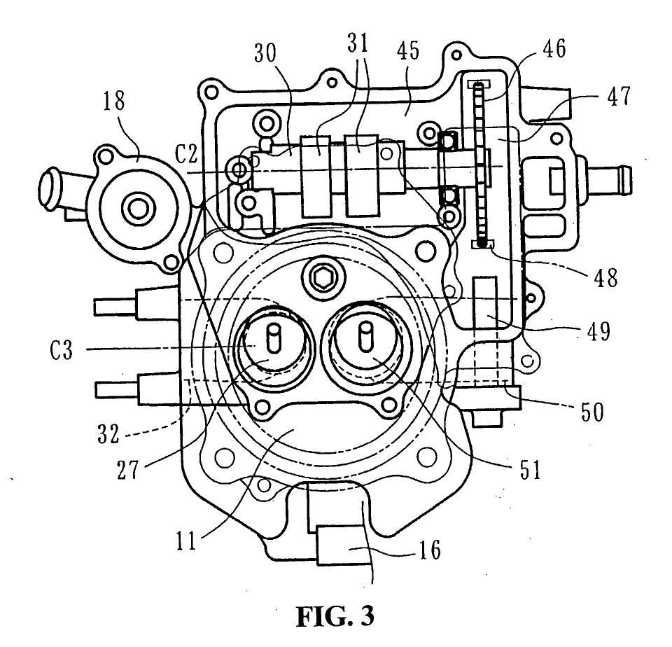

As shown in FIG. 2, a piston 24 is vertically slidably disposed in the cylinder block 10 above the crankshaft chamber 7, and defines a combustion chamber 25 between the piston 24 and the cylinder block 10. An ignition plug 26 and intake and exhaust valves are disposed in the combustion chamber 25. In FIG. 2, only the exhaust valve 27 is visible with the intake valve being concealed from view behind the exhaust valve 27 (see 51 in FIG. 3).

The exhaust valve 27 is actuated by a rocker arm 28 housed in the cylinder head cover 12. The rocker arm 28 has an end oscillated by a cam 31 on a camshaft 30 disposed in the cylinder head 11 through a push rod 29.

An exhaust port 32 is open in a front wall of the cylinder block 10 at a position overlapping the combustion chamber 25. The valve case 14, which is open outwardly, is integrally formed with a left side of the cylinder block 10 in the vicinity of the exhaust port 32. A reed valve 33 is disposed in the valve case 14, which has its open outer side covered with a lid 34. The lid 34 is fastened to the valve case 14 by a bolt 35, thus closing the valve case 14. The lid 34 has a joint port 36 for connection to the secondary air pipe 16.

The reed valve 33 opens and closes a secondary air supply passage connected from the valve case 14 to the exhaust port 32 with exhaust pulsations in the exhaust port 32, thereby intermittently supplying secondary air to the exhaust port 32. The secondary air supply passage is integrally formed in thick portions of the walls of the cylinder block 10 and the cylinder head 11.

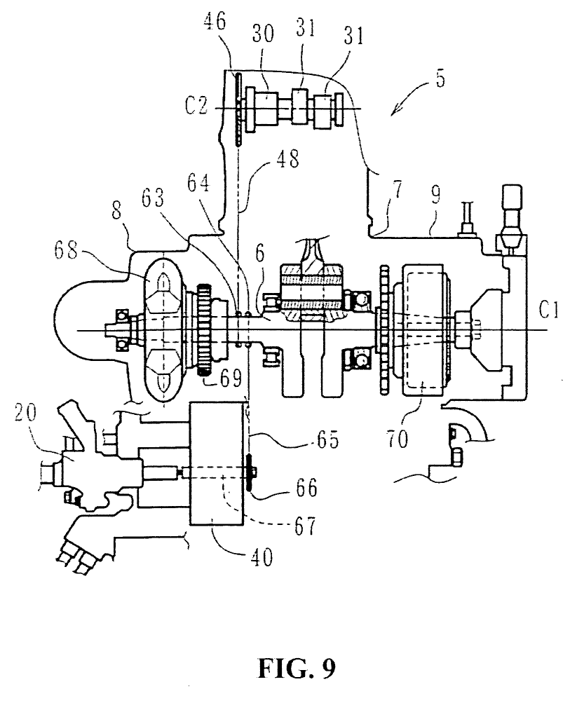

The piston 24 is connected to the crankshaft 6 in the crankshaft chamber 7 by a connecting rod 37. Rotational forces of the crankshaft 6 are output at a certain speed reduction ratio through a torque converter (see FIG. 9), a main shaft 38, and a countershaft 39. The camshaft 30 is also rotated by the rotation of the crankshaft 6 (see FIG. 9).

The water pump 22 and an oil pump 40, which are coaxially actuatable, are disposed in a lower portion of the transmission chamber 8, and are rotated by the crankshaft 6. The water pump 22 delivers a coolant through a water supply hose 41 to the cylinder block 10. The water supply hose 41 extends upwardly substantially along the cylinder axis on a left end of the front surface of the engine 5, is bent inwardly on the front surface of the cylinder block 10, and is connected to a water supply port 42.

The water supply port 42 is positioned substantially centrally of the cylinder on the front surface of the cylinder block 10 below the exhaust port 32, and is connected to a water jacket 43. The water jacket 43 extends through the cylinder block 10 and the cylinder head 11, and communicates with the thermostat housing 18 disposed on a right side of the front surface of the cylinder head 11. The thermostat housing 18 is positioned in the vicinity of the exhaust port 32.

The oil pump 40 supplies lubricating oil through an oil passage 44 extending straight upwardly through the engine 5 toward the camshaft 30, to necessary parts including the crankshaft 6, the connecting rod 37, and the camshaft 30.

As shown in FIG. 3, a camshaft chamber 45 is integrally formed on a right side in the cylinder head 11, and the camshaft 30 is disposed axially in the longitudinal direction of the vehicle body and rotatably supported in the camshaft chamber 45. The camshaft 30 has an axis C2 and the exhaust port 32 has an axis C3 extending substantially parallel to the axis C2. The axes C2, C3 extend in the longitudinal direction of the vehicle body. These axes C2, C3 are also parallel to the axis (see C1 in FIG. 9) of the crankshaft 6.

A cam sprocket 46 is mounted on the rear end of the camshaft 30. The cam sprocket 46 projects into a cam chain chamber 47, which is open as a transverse slender slot in the rear side of the engine 5. In the cam chain chamber 47, the cam sprocket 46 is operatively coupled to a sprocket (not shown) mounted on the crankshaft 6 by a cam chain 48. A chain tensioner 49, an intake port 50, and an intake valve 51 are operatively provided relative to the engine 5.

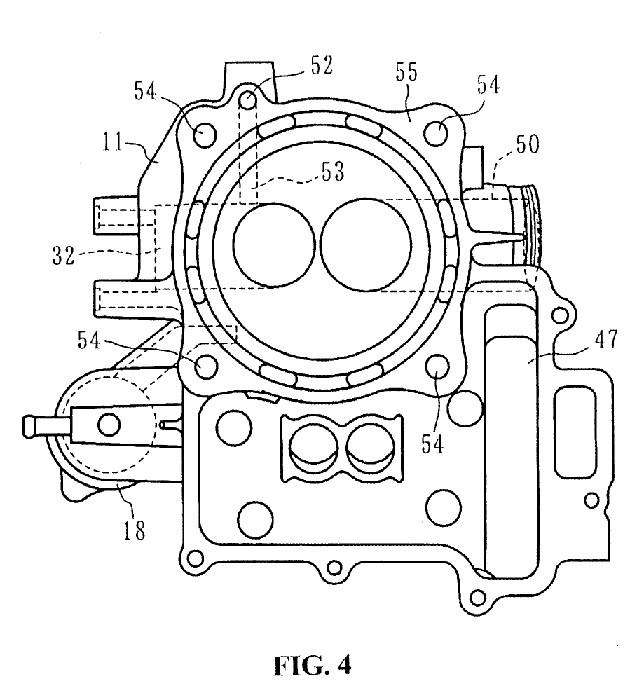

As shown in FIG. 4, a vertical hole 52 is defined in a left side of the cylinder head 11 near the exhaust port 32 and has an upper end communicating with a horizontal hole 53, which is bent substantially horizontally. The horizontal hole 53 is connected to the exhaust port 32. The vertical hole 52 and the horizontal hole 53 serve as part of the secondary air supply passage in the cylinder head 11. Bolt holes 54 and a mating surface 55 to mate with the cylinder block 10 are provided for securing the the cylinder head 11 and the cylinder block 10 together.

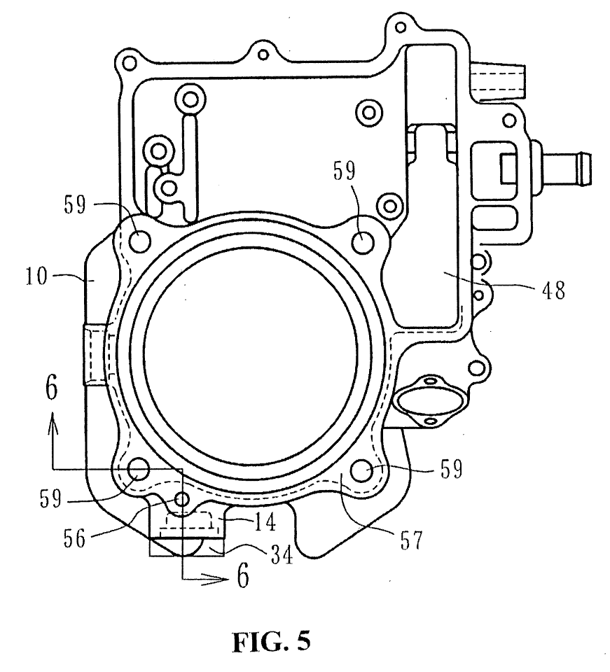

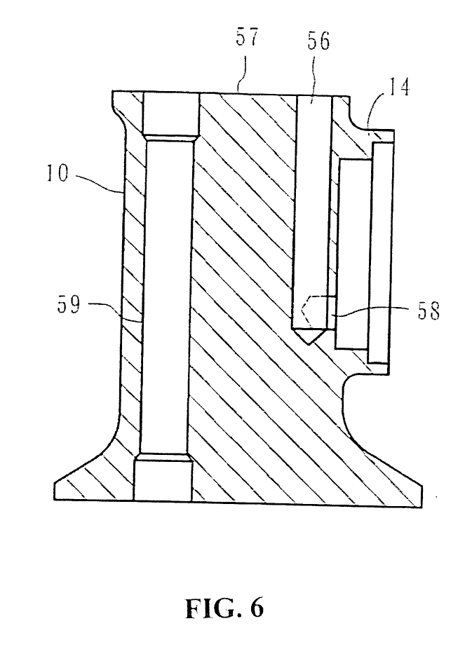

As shown in FIGS. 5 and 6, the cylinder block 10 has a vertical hole 56 defined in a thick left side thereof in alignment with the vertical hole 52. The vertical hole 56 has an upper end that is open at a mating surface 57 of the cylinder block 10, which is to mate with the cylinder head 11, and a lower end communicating with a horizontal hole 58 extending into the valve case 14.

The vertical hole 56 and the horizontal hole 58 serve as part of the secondary air supply passage in the cylinder block 10. When the cylinder block 10 and the cylinder head 11 are combined with each other, the valve case 14, the horizontal hole 58, the vertical hole 56, the vertical hole 52, the horizontal hole 53, and the exhaust port 32 communicate with each other, providing the secondary air supply passage. Bolt holes 59 are aligned with the bolt holes 54. The engine 5 is assembled by bolts (not shown) inserted through these bolt holes 54, 59.

According to the conventional arrangement, the water supply hose 41, which is a coolant pipe for the water-cooled engine, is disposed on the front surface of the engine 5 where the exhaust port 32 is open, and the thermostat housing 18 is disposed on the right side of the front surface of the cylinder head 11. Therefore, since the water supply hose 41, the water supply port 42, and the thermostat housing 18 are positioned in the vicinity of the opening of the exhaust port 32, there is almost no space on the front surface of the cylinder block 10 for installing the reed valve 33 of the exhaust gas purifying device in the vicinity of the exhaust port 32.

However, with the reed valve 33 of the exhaust gas purifying device being on the upper portion of the front end of the left side of the cylinder block 10, which provides an engine side surface perpendicular to the camshaft 30, the reed valve 33 is disposed on the left side surface, which is different from the front surface where the exhaust port 32 is open. As a result, since no camshaft actuating device and no coolant pipe are disposed on the left side surface, the reed valve 33 can be installed without interference therewith, and hence there is a large freedom with which to install the reed valve 33.

Inasmuch as the valve case 14 is disposed on the left side of the vehicle body, the secondary air pipe 16 from the valve case 14 to the air cleaner 15 behind the engine 5 can extend substantially straight without having to extend around the engine 5 from the position in front of the engine 5 through the position above the engine 5. Therefore, the secondary air pipe 16 can easily be laid out and has the desired mechanical strength. Since the secondary air pipe 16 is shorter than the conventional secondary air pipe and does not extend above the engine 5, the overall height of the engine 5 can be reduced, and both the installability of the engine 5 on the vehicle and the maintainability of the valve on the vehicle are improved.

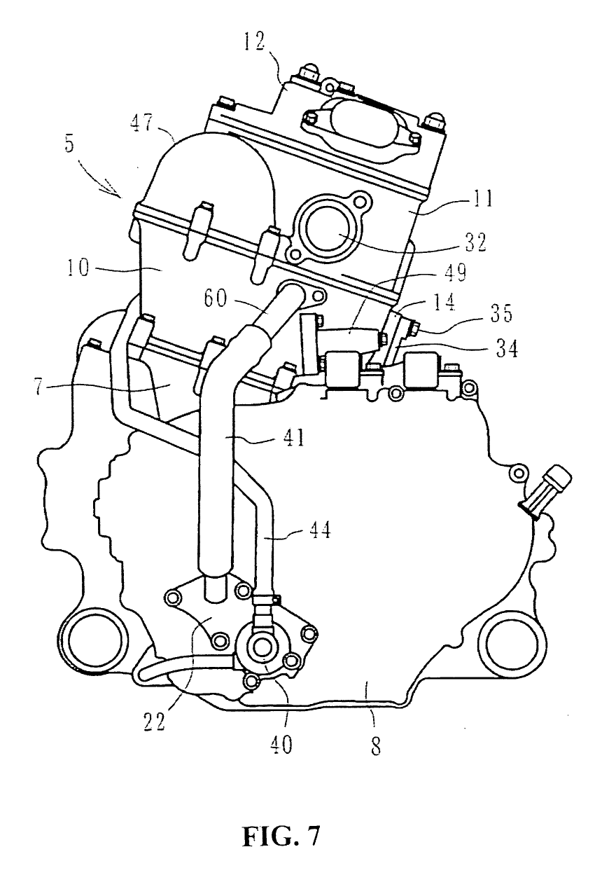

A second embodiment of the present invention will be described below with reference to FIGS. 7 through 9. Those parts common with the previous embodiment are denoted by identical reference numerals.

As shown in FIG. 7, a water supply hose 41 extends from a water pump 22 disposed in a lower portion of a transmission chamber 8 upwardly near the center of a front surface of an engine 5, and is connected to a joint pipe 60 of a water supply port. The joint pipe 60 is disposed directly beneath the exhaust port 32. Although not shown, a return pipe extends through a thermostat disposed in a cylinder head cover 12, and extends from a right side of the cylinder head cover 12 and is connected to an upper water hose.

An oil passage 44 extending from an oil pump 40 that is positioned near the water pump 22 extends upwardly across the front surface of a transmission chamber 8, and is connected to a right side of a cylinder block 10. In the present embodiment, a cam chain chamber 47 is disposed in a front portion of the engine 5, and projects forwardly from a cylinder head 11 to the cylinder block 10. 48 The cam chain chamber 47 in the cylinder head 11 has an upper portion formed in the vicinity of an exhaust port 32. A chain tensioner 49 is disposed on the front surface of the cylinder block 10 and projects to the left of the vehicle body. The leftward projection of the chain tensioner 49 is positioned near a valve case 14 such that it overlaps the valve case 14 as viewed in the front elevation.

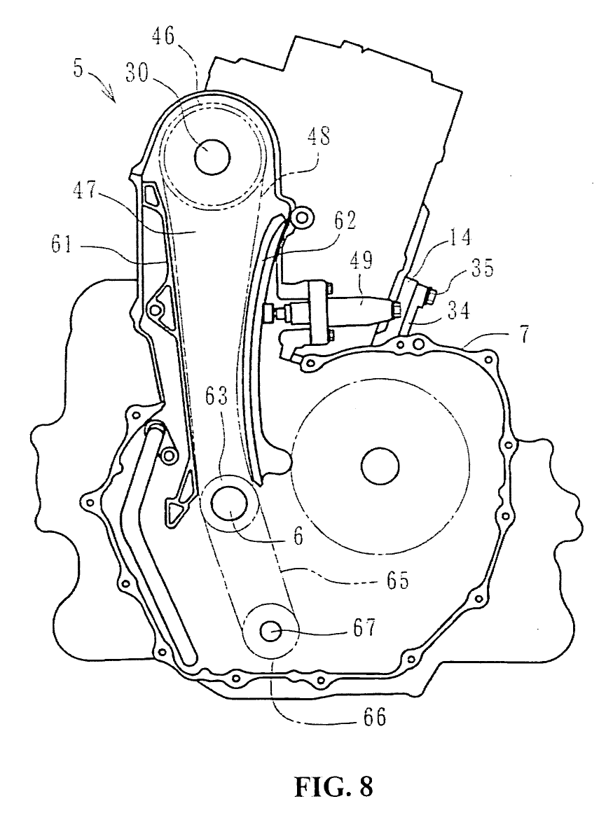

As shown in FIG. 8, the cam chain chamber 47 extends through the cylinder head 11 and the cylinder block 10 into a crankshaft chamber 7, and guides a cam chain 48 with chain guides 61, 62. The cam chain 48 is trained around a cam sprocket 46 and a sprocket 63 mounted on a crankshaft 6.

As shown in FIG. 9, the sprocket 63 and a sprocket 64 are mounted on the crankshaft 6. The sprocket 64 is operatively connected to a pump drive sprocket 66 by a pump drive chain 65. A pump drive shaft 67 actuates the water pump 22 and an oil pump 40 coaxially with each other. A torque converter 68 is mounted on the front end of the crankshaft 6, with an output gear 69 and an ACG 70 mounted on the rear end of the crankshaft 6.

The valve case 14, the air cleaner 15, and the exhaust port 32 are related to each other in the same manner as with the previous embodiment. In the present embodiment, since the water supply hose 41, which is a coolant pipe, the joint pipe 60, and the projecting portion of the cam chain chamber 47 and the chain tensioner 49, which serve as a valve operating mechanism, are disposed near the exhaust port 32 on the front surface of the engine 5, it is more difficult to provide a space for installing the valve case 14 on the front surface of the engine 5.

However, with the valve case 14 disposed on the left side of the cylinder block 10, the above space limitation is eliminated, and the design freedom with which to form the valve case 14 is increased. The second embodiment also offers the same advantages as those of the previous embodiment.

The present invention is not limited to the above embodiments, but various changes and applications may be made within the principles of the invention. For example, the valve case 14 may be positioned on a side of the engine 5, which may be either a left or right side of the vehicle body. The valve case 14 may also be disposed on a side of the cylinder head 11 or a side of the cylinder head cover 12. The reed valve may be replaced with a valve of a suitable type.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An exhaust gas purifying device for a four-cycle engine having a secondary air supply passage for supplying secondary air to an exhaust port and a valve for opening and closing the secondary air supply passage with exhaust pulsations, comprising:
said exhaust port is disposed parallel to a camshaft as viewed in a plan view of the engine, and said valve is disposed on a side of the engine which is perpendicular to said camshaft.

2. The exhaust gas purifying device according to claim 1, wherein said valve is disposed on either a left or right side of a vehicle body, and a pipe for supplying the secondary air is connected between the valve and an air cleaner disposed behind the engine.

3. The exhaust gas purifying device according to claim 1, wherein the secondary air supply passage includes a substantially vertical hole and a substantially horizontal hole disposed in a cylinder block for communicating with the exhaust port.

4. The exhaust gas purifying device according to claim 3, wherein the secondary air supply passage includes a substantially vertical hole and a substantially horizontal hole disposed in a cylinder head for communicating with the exhaust port.

5. The exhaust gas purifying device according to claim 4, wherein said cylinder head is mounted on said cylinder block and said substantially vertical hole and the substantially horizontal hole disposed in the cylinder block and the cylinder head are in communication with each other and with the exhaust port.

6. The exhaust gas purifying device according to claim 5, and further including a secondary air supply conduit operatively connected to an air cleaner and said substantially vertical hole and the substantially horizontal hole disposed in the cylinder block and the cylinder head for communicating air to the exhaust port.

7. The exhaust gas purifying device according to claim 5, wherein said valve is a reed valve operatively positioned relative to the substantially vertical hole and a substantially horizontal hole disposed in the cylinder block and the cylinder head for selectively permitting communication between the secondary air supply conduit and the exhaust port.

8. The exhaust gas purifying device according to claim 7, wherein said reed valve is disposed relative to the substantially horizontal hole disposed in the cylinder block.

9. An exhaust gas purifying device for a four-cycle engine comprising:
an exhaust port;
a secondary air supply passage for supplying secondary air to the exhaust port; and
a valve for selectively opening and closing the secondary air supply passage in response to exhaust pulsations;
wherein said exhaust port is disposed parallel to a camshaft as viewed in a plan view of the engine and said valve is disposed on a side of the engine which is perpendicular to said camshaft.

10. The exhaust gas purifying device according to claim 9, wherein said valve is disposed on either a left or right side of a vehicle body, and a pipe for supplying the secondary air is connected between the valve and an air cleaner disposed behind the engine.

11. The exhaust gas purifying device according to claim 9, wherein the secondary air supply passage includes a substantially vertical hole and a substantially horizontal hole disposed in a cylinder block for communicating with the exhaust port.

12. The exhaust gas purifying device according to claim 11, wherein the secondary air supply passage includes a substantially vertical hole and a substantially horizontal hole disposed in a cylinder head for communicating with the exhaust port.

13. The exhaust gas purifying device according to claim 12, wherein said cylinder head is mounted on said cylinder block and said substantially vertical hole and the substantially horizontal hole disposed in the cylinder block and the cylinder head are in communication with each other and with the exhaust port.

14. The exhaust gas purifying device according to claim 13, and further including a secondary air supply conduit operatively connected to an air cleaner and said substantially vertical hole and the substantially horizontal hole disposed in the cylinder block and the cylinder head for communicating air to the exhaust port.

15. The exhaust gas purifying device according to claim 13, wherein said valve is a reed valve operatively positioned relative to the substantially vertical hole and a substantially horizontal hole disposed in the cylinder block and the cylinder head for selectively permitting communication between the secondary air supply conduit and the exhaust port.

16. The exhaust gas purifying device according to claim 15, wherein said reed valve is disposed relative to the substantially horizontal hole disposed in the cylinder block.
